(19) United States
(12) Patent Application Publication
(10) Pub. No.: US 2014/0341652 A1
(43) Pub. Date: Nov. 20, 2014

(54) METHOD FOR DRAINING SOIL USING A FILTRATION MEANS

(71) Applicants: Eldert Besseling, LG Hendrik Ido Ambacht (NL); Frank De Groot, LG Hendrik Ido Ambacht (NL); Hugo Hendrikus Martinus Ekkelenkamp, LG Hendrik Ido Ambacht (NL)

(72) Inventors: Eldert Besseling, Hendrik Ido Ambacht (NL); Frank Arie De Groot, Hendrick Ido Ambacht (NL); Hugo Hendrickus Martinus Ekkelenkamp, Hendrick Ido Ambacht (NL)

(21) Appl. No.: 14/359,702

(22) PCT Filed: Nov. 21, 2012
(86) PCT No.: PCT/NL2012/050829

§ 371 Date: May 21, 2014

(30) Foreign Application Priority Data
Nov. 21, 2011 (NL) 2007821

(51) Int. Cl. B09C 1/00; C02F 11/12; E02B 11/00

(52) U.S. Cl. CPC B09C 1/00; E02B 11/00; C02F 11/123
USPC 405/50; 210/499

(57) ABSTRACT

The present invention concerns a method for draining soil such as dredger sludge using a filtration means, comprising the steps of: forming a support layer for supporting a quantity of soil, placing the filtration means on the support layer such that the periphery of the filtration means essentially connects to the support layer and forms a space between the filtration means and the support layer, filling the space between the filtration means and the support layer with soil, draining the soil under the influence of gravity, removing the filtration means from the at least partly drained soil and removing the at least partly drained soil from the support layer.

The present invention concerns a method for draining soil, such as dredger sludge, using a filtration means.

Such a method for draining soil using a tubular or sleeve-like filtration means is known. Here the filtration means is deposited and then filled with soil. Then the soil is at least partly drained and the filtration means removed. The filtration means must be cut open, whereupon the at least partly drained soil is excavated.

A problem with the known method for draining soil is that the filtration means is damaged on removal and cannot be reused.

An object of the present invention is to provide a method for draining soil using a filtration means, wherein the filtration means is not damaged and therefore can be reused.

This object is achieved by a method for draining soil using a filtration means, comprising the steps of: forming a support layer to support a quantity of soil, placing a filtration means on the support layer such that the periphery of the filtration means substantially connects to the support layer and forms a space between the filtration means and the support layer, filling the space between the filtration means and the support layer with soil, draining the soil such as under the influence of gravity, by use of a flocculant or by means of the injection pressure present on filling, removing the filtration means from the at least partly drained soil and removing the at least partly drained soil from the support layer.

With the steps cited in the method, it is achieved that the entire filtration means can be reused. The term “support layer” should be interpreted broadly: the support layer can relate to any arbitrary, rigid subsoil which offers sufficient resistance to the pressure of the soil mass present thereon, but also to a separate support layer which is created on the subsoil and can for example comprise adjacent support elements such as metal plates.

By creating a separate wear-resistant support layer below the soil to be drained, the support layer is prevented from being damaged beyond repair on removal of the at least partly drained soil. The creation of a removable filtration means on the top prevents having to cut open the filtration means in order to expose and excavate the at least partly drained soil.

It must be emphasised that “soil” can relate to dredger or river sludge, but also for example to soil-like material such as mixtures of clay, sand, minerals, or ores such as are found for example in a mine.

Secondly it should be noted that the method described in the present application can be used for draining equivalent mixtures of water and solids with a relatively high density. This could comprise draining waste products such as are found for example in the agricultural sector, in particular dung.

The support layer can also be formed advantageously by one or more adjacent support elements. In this way a relatively great flexibility can be achieved in relation to the installation and reuse of the support layer. A further advantage is flexibility with regard to the size of the area of the support layer to be formed.

Furthermore the method according to the invention comprises the placing of a frame around at least part of the support layer, wherein the filtration means is connected to the frame or fixed by the frame in relation to the support layer. This results in the filtration means being able to be placed on or removed from the support layer relatively quickly. Also a degree of form stability of the filtration means is achieved, which simplifies installation and use. Such a frame can for example be formed of a continuous profile such as an I-profile or a tubular or cylindrical profile. Instead of being fixed to the frame, the filtration means can also be clamped between the frame and the support layer.

In addition, in the method according to the invention, the frame can be formed by connecting frame pieces together. By using frame pieces, a relatively great flexibility can be achieved with regard to the formation i.e. construction and dismantling of the frame.

Preferably such a frame comprises a tubular element. Also a cylindrical element is conceivable. Such a tubular element is relatively easy to connect with another tubular element to form a continuous frame. This connection can for example be achieved using an adapter. Also the tubular elements can be joined together by push-fit for example. Here it is advantageous that the frame pieces of the frame are placed separately on the support elements. Furthermore other fixing methods are conceivable: the frame pieces or the frame can for example also be attached to the support element or the subsoil using clamps. The position of these clamps depends on the wishes of the user.

Furthermore it is advantageous that the method according to the invention comprises, after removal of the at least partly drained soil, the removal of the support layer. The person skilled in the art will understand that this is only possible if the support layer is placed on a subsoil and not if the subsoil itself forms the support layer. Thus as well as the filtration means, the support layer can also be reused. By using several support elements, the support layer is easy to dismantle.

It is also advantageous that in the method according to the invention the space between the filtration means and the support layer can be filled with soil via one or more filling openings made in the filtration means, such as a filling opening of the type Ten Cate Geoport®. The filling opening offers relatively easy access to the space enclosed by the filtration means and the support layer. If the filling opening is located on the top of the filtration means in use, use can advantageously be made for example of gravity or the injection pressure to press the soil, for example the dredger sludge, into the enclosed space. Another possibility is the use of a so-called filler tube to achieve the above.

Furthermore it is advantageous that in the method according to the invention, the filtration means is removed by tilting this in relation to the support layer with or along one edge of the frame. Tilting can take place using a motorized tool, for example an excavator, more particularly an excavator which is also used to excavate the at least partly drained soil, by exerting a tensile force on at least part of the frame. It is also possible to tilt the frame without using a tool.

A further aspect of the invention concerns a filtration means apparently intended for use in said method according to the invention, fitted with a fabric part and fixing pieces mounted on the fabric part for fixing the fabric part to the support layer or the frame. Such a filtration means can be attached to the frame or support layer relatively quickly and easily. Here it is furthermore advantageous that on the filtration means, a fixing piece comprises a loop. A loop is relatively easy to attach to the frame, in particular to tubular or cylindrical frame pieces or to further fixing parts located on or around the support layer.

A further aspect of the invention also concerns a filtration means apparently intended for use in a method according to the invention, fitted with a fabric part and a thickening arranged on a periphery of the fabric part, wherein the thickening is attached such that under an inwardly directed force on the fabric part, the fabric part remains hooked below the frame. The thickening can for example advantageously comprise a stitched-in cord. The filtration means can thus be pressed by the frame onto the support elements. The thickening prevents the fabric part being able to slip below the frame under an inwardly directed force on the fabric part or an inward movement.

The filtration means can advantageously comprise a textile material, for example of the woven or non-woven or knitted type. Also non-textile materials with sufficient filtration effect can be used. The filtration means can advantageously comprise several filtration layers such as a first filtration layer with woven fabric and a second filtration layer with fleece. Ideally the different filtration properties of the layers are used to optimize the filtration.

Here it is also advantageous that, in a filtration means according to the invention, the fabric part is fitted with one or more filling openings on its top side in use. The filling opening as already stated offers relatively easy access to the space surrounded by the filtration means and support layer. If the filling opening is located on the top of the filtration means during use, use can advantageously be made of gravity to allow soil into the enclosed space.

It is also advantageous that the filtration means according to the invention has a double curvature to form a sleeve enclosing a cavity. Using such a preformed cavity it is relatively easier to fill the filling cavity with soil. In addition it is relatively easier to perform said tilting movement to remove the filtration means from the support layer.

Yet a further aspect of the invention concerns a support layer apparently intended for use in a method according to the invention, fitted with a plate-like part on which is mounted a fixing part for a frame piece. Such a support element on which a fixing part for a frame piece is mounted can be placed relatively quickly next to further support elements. Then a frame piece can be attached to a fixing part. The frame pieces can be connected relatively quickly with the frame pieces of adjacent elements to form a continuous frame.

In addition it is advantageous that the plate-like part of said support element is made of steel. Steel has a good form stability and is also relatively resistant to various weather influences. Other advantageous materials are for example wood, plastic, or materials with a fibre structure.

Further advantages of the filtration device according to the invention are a relatively high form stability and a relatively high water permeability. The increased form stability leads to an improvement in the filtration properties because a relatively large effective contact surface is formed between the soil to be drained and the filtration means.

Also, German patent publication DE 20.2006.011790 discloses a cylindrical holder for draining dredged sludge with, on the underside, a base with a valve and, on the top, a lid-like body. Between the outer periphery of the base and the outer periphery of the lid-like body is mounted a cylindrical filter net. To drain the dredged sludge or mud, this is added to the cylindrical holder via an opening in the lid-like body. The water present flows out via the filter net, whereupon the drained sludge remains in the holder.

The cylindrical holder is then lifted as a whole using for example a forklift truck and the valve in the base is opened so that the drained sludge falls out.

A significant disadvantage of this solution is that the holder is intended only for relatively small filling volumes: in contrast, the present invention is ideally suited for relatively large filling volumes of preferably 50 m³ or more, more preferably 50 to 500 m³, and relatively large filling flow rates of preferably more than 25 m³/h, more preferably 50 to 150 m³/h.

Also lifting of the filled holder requires the exercise of considerable force. The present invention in contrast allows the drained soil to remain on the support layer.

PCT patent publication WO 2006/014746 also describes a filter bag for a swimming pool vacuum cleaner. Such a filter bag is not however suitable for use as filter material in the present method.

American patent publication U.S. Pat. No. 5,035,800 in addition describes a sieve which can be placed over a pan or similar cooking utensil. When the pan is tilted, the water present in the pan flows out of the pan through the sieve. The sieve as described in this publication is not however suitable for draining soil, as the person skilled in the art will understand.

The invention will now be explained in more detail with reference to an embodiment example using the figures, in which:

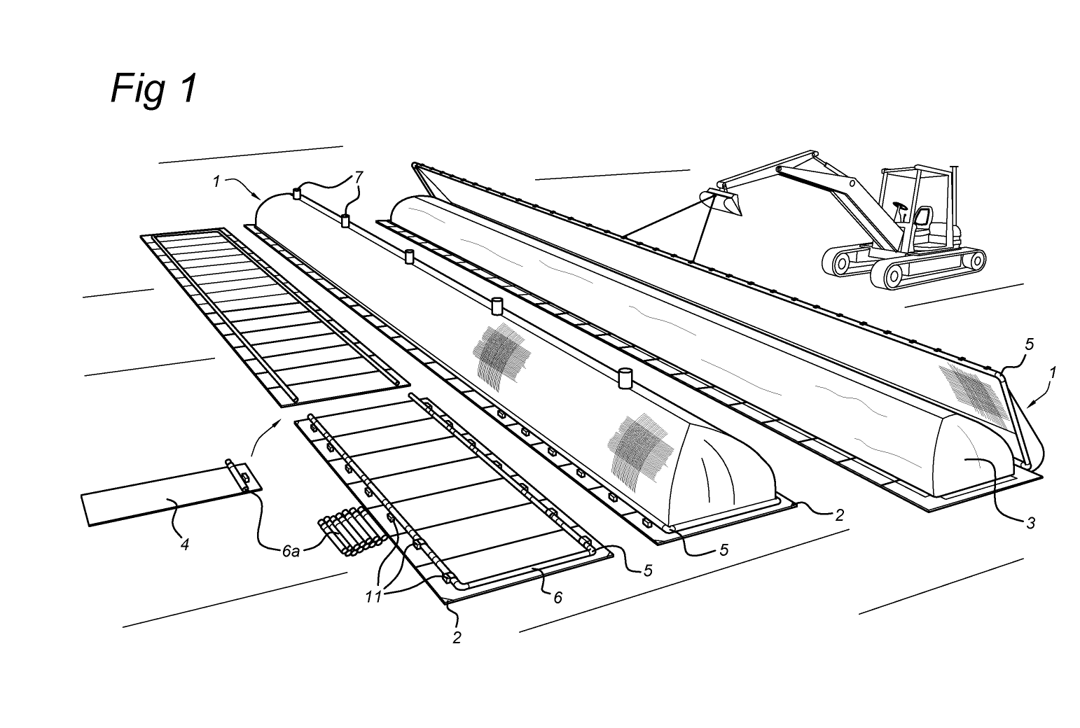

FIG. 1 shows a diagrammatic depiction of elements of the method according to the invention;

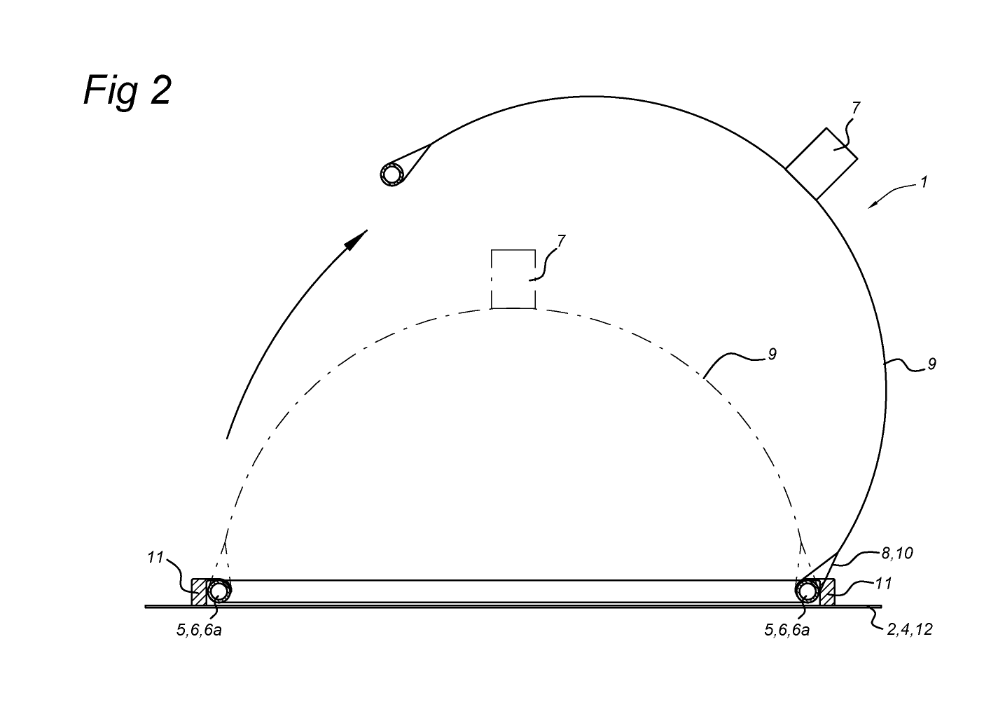

FIG. 2 shows a cross-sectional view of a support layer with a filtration means attached removably thereon; and

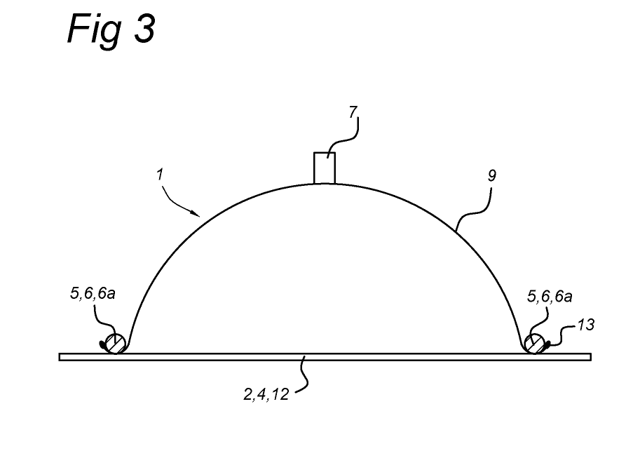

FIG. 3 shows a cross-sectional view of a support layer with a filtration means attached removably thereon, fitted with a thickening.

In the description of the figures below, corresponding parts are indicated with identical reference numerals.

FIG. 1 shows a diagrammatic depiction of elements of the method according to the invention. More specifically FIG. 1 from left to right shows three aspects of the invention, namely: a support layer 2, the support layer with a filtration means 1 attached thereon, and a filtration means 1 partly removed from the support layer 2.

At the far left in FIG. 1 a support element 4 is shown. The support layer 2 can be formed by placing several such support elements 4 against each other. In addition the support layer 2 (where possible) can be formed by a sufficiently rigid subsoil. If the support layer is formed by the subsoil, it may be necessary to compact the subsoil to give sufficient rigidity. The support element 4 in FIG. 1 is fitted with a frame piece 6. The frame piece 6 comprises a tubular part 6a. The frame piece 6, when support elements 4 are placed against each other, serves to form a continuous frame 5. The tubular parts 6a are connected together. The frame 5 serves to attach the filtration means 1 by means of fixing pieces (not shown) attached to the filtration means 1. The frame 5 runs essentially along the outside of the support layer 2. A frame piece 6 is attached to a support element 4 by means of a fixing part 11 which is mounted on the support element 4.

In the middle of FIG. 1 a support layer 2 is shown on which the filtration means 1 is attached. The filtration means 1 has several filling openings 7 on the top in use. By means of the filling openings 7, the filling space between the filtration means 1 and the support layer 2 can be filled with soil. By means of fixing pieces (not shown), the filtration means 1 is connected to the frame 5. The frame 5 is connected to the support layer 2 via fixing parts 11. When the support layer 2 is formed by a subsoil, the fixing parts 11 can be attached directly onto or into the subsoil.

At the far right in FIG. 1, the removal of the filtration means 1 by means of an excavator tool is shown. The excavator tool for example makes a connection with the frame 5 via cables. The frame 5 is then tilted by the excavator tool. The frame 5 and the connected filtration means 1 are then removed as a whole. The at least partly drained soil 3 remains on the support layer 2 for excavation. After excavation of the soil 3 the support layer 2, as shown in FIG. 1, can be reused by separating the support elements 4 from each other.

FIG. 2 shows in perspective a cross-sectional view of a support layer 2 with filtration means 1 attached removably thereon. The filtration means 1 is shown in two positions.

The first position shows the filtration means 1 attached to the support layer 2 by means of the frame 5 which is connected with fixing parts 11. The filtration means 1 for this is fitted with a fixing piece 8. In the embodiment of FIG. 2, the fixing piece 8 comprises a loop 10 to connect the filtration means 1 with the frame 5. FIG. 2 also shows the support layer 2 which can comprise one or more support elements 4. A support element 4 can comprise a plate-like part 12 with the fixing part 11 attached thereon. The filtration means 1 shown in FIG. 2 comprises a fabric part 9, a filling opening 7 positioned on the fabric part 9 and, as already mentioned, a fixing piece 8.

The second position shows the filtration means 1 in a partly removed position. The filtration means 1 is here tilted to the right. It is also possible to tilt the filtration means in another direction. The left side of the filtration means 1 shown in FIG. 2 is separated from the fixing part 11 on the left side of the support layer 2. It is also possible to remove the filtration means 1 from the support layer 2 by lifting it as a whole. This can be achieved for example with a hoist crane. The hoist crane can lift the entire filtration means 1 from the support layer 2 by means of a suitable connection with the filtration means 1 or the frame 5.

FIG. 3 shows a cross-sectional view of a support layer 2 with a filtration means 1 which is attached removably thereto and is fitted with a fabric part 9 with a thickening 13 at its edge. The thickening 13 is attached such that under an inwardly directed force on the fabric part 9, the fabric part 9 will remain hooked behind the frame 5. The thickening 13 can for example advantageously be a stitched-in cord. The filtration means 1 can thus be pressed by the frame 5 onto the support layer 2, for example under the weight of the frame 5 itself. The thickening 13 prevents the fabric part 9 from being able to slip below the frame 5 under an inwardly directed force on the fabric part 9 or its inward movement. Furthermore other fixing methods are conceivable such as fixing of the fabric part 9 to the support layer 2, wherein the support layer 2 is fitted with rings or eyes onto which can be fastened ropes or cables attached to the fabric part 9.

It should also be clear that the above description is intended to illustrate the function of preferred embodiments of the invention and does not restrict the scope of the invention. Starting from the above explanation, many variations which fall under the spirit and scope of the present invention will be evident to the person skilled in the art.

### List of Reference Numerals

1 Filtration means
2 Support layer
3 Drained soil
4 Support element
5 Frame
6 Frame piece, 6a Tubular part
7 Filling opening
8 Fixing piece
9 Fabric part
10 Loop
11 Fixing part
12 Plate-like part
13 Thickening

1. Method for draining soil using a filtration means, comprising the steps of:
forming a support layer for supporting a quantity of soil,
placing the filtration means on the support layer such that the periphery of the filtration means substantially connects to the support layer and forms a space between the filtration means and the support layer,
filling the space between the filtration means and the support layer with soil,
draining the soil, such as under the influence of gravity,
removing the filtration means from the at least partly drained soil, wherein the at least partly drained soil remains on the support layer, and
removing the at least partly drained soil from the support layer.

2. Method according to claim 1, wherein the support layer is formed by several adjacent support elements.

3. Method according to claim 1, comprising the placing of a frame around at least part of the support layer, wherein the filtration means is connected to the frame or fixed by the frame relation to the support layer.

4. Method according to claim 3, wherein the frame is formed by frame pieces connected together in use.

5. Method according to claim 4, wherein a frame piece comprises a tubular element.

6. Method according to claim 5, wherein the frame pieces the frame are placed separately on the support elements.

7. Method according to claim 1, comprising, after removal of the drained soil, the removal of the support layer.

8. Method according to, wherein the space between the filtration means and the support layer is filled with soil via a filling opening made in the filtration means.

9. Method according to claim 1, wherein the filtration means is removed by tilting this in relation to the support layer along one edge of the frame.

10. Filtration means intended for use in a method according to claim 1, fitted with a fabric part and fixing pieces mounted on the fabric part for attaching the fabric part the support layer or the frame.

11. Filtration means intended for use in a method according to Claim 1, fitted with a fabric part and a thickening arranged on the periphery of the fabric part, wherein the thickening is attached such that under an inwardly directed force on the fabric part, this remains hooked below the frame.

12. Filtration means according to claim 10, wherein a fixing piece comprises a loop.

13. Filtration means according to claim 10, wherein the fabric part is fitted with a filling opening in its top side in use.

14. Filtration means according to claim 10, wherein this has a double curvature to form a sleeve enclosing a cavity.

15. Support element intended for use in a method according to claim 2, fitted with a plate-like part on which is mounted a fixing part for a frame piece.
